(19) United States
(12) Patent Application Publication
(10) Pub. No.: US 2005/0122413 A1
(43) Pub. Date: Jun. 9, 2005

(54) Solid-state image pickup device and image signal processor

(75) Inventor: Hisashi Matsuyama, Ryoke-cho (JP)

Correspondence Address: OLIFF & BERRIDGE, PLC, P.O. BOX 19928, ALEXANDRIA, VA, 22320, US

(73) Assignee: Sanyo Electric Co., Ltd., Moriguchi-shi (JP)

(21) Appl. No.: 10/990,449

(22) Filed: Nov. 18, 2004

(30) Foreign Application Priority Data
Dec. 5, 2003 (JP) 2003-406970

(51) Int. Cl. H04N 5/335

(52) U.S. Cl. 348/272

(57) ABSTRACT

In a CCD image sensor mounted with a mosaic filter, when color components are separated from an image signal obtained by additively synthesizing plural lines, there is a problem that a vertical resolution is deteriorated. In a color filter to be fitted to the image sensor, G and B are alternately arranged in odd columns, R and G are alternately arranged in even columns, the arrangement cycles of adjacent odd columns are deviated by one pixel in a column direction from each other, and the arrangement cycles of adjacent even columns are deviated by one pixel in the column direction from each other. An image signal processor extracts data D(a, b) and D(a, b+2) deviated by two columns from the same line (a-th line) of an image signal obtained by additively synthesizing three lines with the image sensor. D(a, b) includes a color Cx corresponding to two pixels and a color Cy corresponding to one pixel, and D(a, b+2) includes a color Cx corresponding to one pixel and a color Cy corresponding to two pixels. The color component values <Cx> and <Cy> at a sampling point P(a, b) are obtained by <Cx>=[2D(a, b)−D(a, b+2)]/3 and <Cy>=[2D(a, b+2)−D(a, b)]/3.

### CROSS-REFERENCE TO RELATED APPLICATIONS

The priority application No. JP2003-406970 upon which this patent application is based is hereby incorporated by reference.

### FIELD OF THE INVENTION

The present invention relates to a solid-state image pickup device in which pixels having different color sensitivity characteristics are arranged in a mosaic shape and an image signal processor for processing output image signals of the solid-state image pickup device. More specifically, the present invention relates to a technology which is used for obtaining an image compressed in a column direction by an additive synthesis of plural lines and generating an image signal for each color component on the basis of image signals of which colors are mixed through the additive synthesis.

### BACKGROUND OF THE INVENTION

Recently, the number of pixels of solid-state image pickup devices mounted on digital cameras or mobile phones having a camera function has been increased, and the apparatuses typically have a function of previewing images to be photographed with a display unit. There have been suggested apparatuses which can perform the moving picture photographing as well as the still picture photographing.

It is required for the preview operation or the moving picture photographing that the images should be repeatedly processed and displayed or recorded in a relatively short cycle. However, it is not easy to read out information of pixels from high-resolution CCD image sensors at a high frame rate, because there are problems in that the transfer clock frequencies of horizontal shifter registers particularly increase, and transfer efficiency deteriorates or heat emission and power consumption increase.

Meanwhile, the number of pixels of the solid-state image pickup devices is remarkably larger than the number of pixels of preview monitors. For this reason, when images are recorded in recording mediums such as memories or the like, the images are photographed with a high resolution corresponding to the number of pixels of the solid-state image pickup devices. However, at the time of preview, it may be sufficient to photograph the images with a low resolution corresponding to the number of pixels of the preview monitors. In addition, the moving pictures do not require the high resolution of the still picture in view of human vision characteristic, so that the moving pictures may be photographed with a resolution lower than the still picture for the purpose of decreasing the recording data quantity.

For this reason, at the time of the preview or the moving picture photographing, by reading out the information charges stored in the imaging portions of the CCD image sensors only about interlaced lines, or by additively synthesizing plural lines and reading out the information charges, the image signals of which the resolution is lowered in the column direction (vertical direction) are outputted, so that the number of horizontal transfers for each screen could be suppressed.

In the CCD image sensors comprising a color filter in which plural colors are arranged in a column direction as in a bayer-type filter, when the information charges of plural lines are additively synthesized in the column direction and read out, the information charges of a plurality of pixels having different color-sensitivity characteristics are mixed. That is, the image signals into which plural color components are mixed are outputted from the CCD image sensors.

FIG. 1 is a schematic diagram illustrating an arrangement of the bayer-type color filter. As a method of separating the respective color components from the image signals obtained by additively synthesizing plural lines in the CCD image sensor comprising the bayer-type color filter, a conventional method will be described. In FIG. 1, for the purpose of providing a clear description, a line number α is sequentially numbered from the line closest to the horizontal shift register (horizontal transfer portion) and a column number β is sequentially numbered from the column closest to the output terminal of the horizontal transfer portion. The bayer-type color filter shown in FIG. 1 comprises, for example, three colors of R (red), G (green) and B (blue), and a color (color sensitivity characteristic) C(α, β) of the light-sensitive pixel specified by the line number α and the column number β is determined, for example, as follows.
C(2λ−1, 2μ−1)=B
C(2λ, 2μ)=R
C(2λ−1, 2μ)=C(2λ, 2μ−1)=G (where λ and μ are natural numbers) (1)

The additive synthesis of the information charges stored in the plural lines corresponding to the respective pixels of the imaging portion might be performed, for example, by the horizontal transfer portion comprising a horizontal shift register. The information charges obtained from the imaging portion are sequentially transferred in units of line to the horizontal transfer portion from the vertical shift register of the imaging portion in an interline transfer type CCD image sensor and from the vertical shift register of the storage portion in a frame transfer CCD image sensor. By repeatedly performing the line transfer with the driving of the horizontal shift register stopped, the information charges of the plural lines are stored and added in the horizontal shift register and thus the additive synthesis of the plural lines are embodied. At this time, the charges obtained by synthesizing the information charges from a plurality of pixels continuously extending in the column direction are stored in the respective bits of the horizontal shift register, and when the horizontal shift register is driven, the signal corresponding to the synthesized information charges are outputted as the image signal of one line (synthesized image signal) from the output portion.

In the filter arrangement defined by the expression (1), a pixel set comprising G and B is repeatedly arranged in the odd columns of the light-sensitive pixels arranged in a matrix shape like B, G, B, G, . . . . On the other hand, a pixel set comprising R and G are repeatedly arranged in the even columns like G, R, G, R, . . . . For this reason, the R and G components or the G and B components are synthesized and included in the information charges obtained by additively synthesizing the plural lines. In order to allow the color components to be separated, the number of lines to be additively synthesized is set to the odd lines, for example, three. In this case, the synthesized image signal of the a-th line (a≧1) outputted from the CCD image sensor is generated through the synthesis of the information charges of the (3a−2)th to 3a-th lines of the imaging portion. Here, by setting the number of lines to be added to the odd number, in the signal values corresponding to the same column among the synthesized image signals of the a-th line and the (a+1)th line outputted from the CCD image sensor, the same color components are mixed and the mixture ratios are different from each other. The signal processing circuit which has received the image signals outputted from the CCD image sensor performs a color separating process using the received image signals.

Now, the signal value corresponding to a pixel of the α-th line and the β-th column in the imaging portion of the CCD image sensor is indicated by R(α, β), G(α, β) and B(α, β) corresponding to the colors R, G, and B of the pixel, and the image signal value corresponding to a pixel of the b-th column of the imaging portion in the output image signal of the a-th line outputted from the CCD image sensor is indicated by D(a, b).

In the arrangement of the color filter in FIG. 1 expressed by the expression (1), there exist the following four kinds of which the color-mixed ratios are different from each other in the image signal values obtained by additively synthesizing three lines.
D(2λ−1, 2μ−1)=B(6λ−5, 2μ−1)+G(6λ−4, 2μ−1)+B(6λ−3, 2μ−1) (2)
D(2λ, 2μ−1)=G(6λ−2, 2μ−1)+B(6λ−1, 2μ−1)+G(6λ, 2μ−1) (3)
D(2λ−1, 2μ)=G(6λ−5, 2μ)+R(6λ−4, 2μ)+G(6λ−3, 2μ) (4)
D(2λ, 2μ)=R(6λ−2, 2μ)+G(6λ−1, 2μ)+R(6λ, 2μ) (5)
(where λ and μ are natural numbers)

The signal processing circuit generates the separated image signals for each color component of R, G, and B on the basis of the color-mixed signal values obtained from the expressions (2) to (5) at the time of previewing or photographing a moving picture. The generated image signals have a lower resolution than that of the normal operation that the plural lines are not additively synthesized, and the vertical arrangement cycle of sampling points set in the images depends on the number of lines to be additive synthesized by the CCD image sensor. That is, one sampling point is positioned every three lines with respect to the vertical direction.

The signal processing circuit uses the expressions (2) and (3) for the odd columns and uses the expressions (4) and (5) for the even columns to calculate the color-component signal value at the sampling points corresponding to a position of a pixel area having six pixels, on the basis of the information charges obtained from the six pixels continuously extending in the column direction.

As a specific example of the color separation process, a process performed to the pixel area having continuous six pixels in an odd column will be described. It is supposed in accordance with the expressions (2) and (3) that the pixel area as a process target is an area having six pixels positioned in the (6λ−5)th to 6λ lines in the (2−1)th column. The signal processing circuit calculates the G signal value <G>(≡<G(2λ−1, 2μ−1)>) and the B signal value <B>(≡<B(2λ−1, 2μ−1)>) at the sampling points P(2λ−1, 2μ−1) representing the pixel area as a process target. At this time, in the approximation that the values of G and B in the pixel area are considered as constant values <G> and <B>, the expressions (2) and (3) become as follows:
D(2λ−1, 2μ−1)=<G>+2<B> (6)
D(2λ, 2μ−1)=2<G>+<B> (7)
Accordingly, the signal values <G> and <B> at the sampling points of the pixel area are obtained as follows:
<G>=[2D(2λ, 2μ−1)−D(2λ−1, 2μ−1)]/3 (8)
<B>=[2D(2λ−1, 2μ−1)−D(2λ, 2μ−1)]/3 (9)
The signal processing circuit obtains <G> and <B> by calculating the expressions (8) and (9).

The signal values <R> and <G> of R and G at the sampling points P(2λ−1, 2μ) for the pixel area having six pixels positioned at the (6λ−5)th to 6λ in the even column (2μ-th column), are determined similarly on the basis of the expressions (4) and (5). In this way, a group of signal values <G> and <B> or <R> and <G> for each column is obtained from the (2λ−1)th line and the 2λ-th line of the synthesized image signal.

Similarly, a group of signal values <G> and <B> or <R> and <G> for each column is obtained from the 2λ-th line and the (2λ+1)th line of the synthesized image signal. By shifting the group of synthesized image signals having two lines which is used for the color separation process by one line and performing the color separation process, a color component signal having the same number of lines as the synthesized image signal is obtained.

As described above, in the CCD image sensor, the frame rate can be enhanced by additively synthesizing and reading out plural lines (n lines), but in the CCD image sensor mounted with the color filter having the mosaic arrangement, it is generally necessary to separate the color component signals from the synthesized image signal.

Conventionally, the color component signal at one sampling point is calculated on the basis of the signal value corresponding to the same column position using two lines of synthesized image signals. That is, the color component signal at one sampling point is influenced by the information charges of 2n pixels (pixel area of 2n lines×one column) extending continuously in the column direction. For this reason, there are problems in that the difference between the vertical resolution (in the column direction) and the horizontal resolution (in the line direction) is increased or that the vertical resolution may be decreased more than the number of lines to be additively synthesized.

### SUMMARY OF THE INVENTION

The present invention is made to solve the above problems, and it is an object of the present invention to provide a solid-state image pickup device and an image signal processor, in which a vertical resolution can be maintained better when color component signals are separated from a read-out synthesized image signal by additively synthesizing plural lines and an excellent image of which the vertical and horizontal resolutions become close to each other can be obtained.

According to an aspect of the present invention, there is provided a solid-state image pickup device, in which for each partial column positioned within a predetermined range of lines to be subjected to an additive synthesis in a column direction among light-sensitive pixel columns, a partial column set including L (L≧2) partial columns Fⱼ (1≦j≦L) which include each partial column and have a predetermined positional relation in a line direction is defined, in which the number of partial columns L included in the partial column set is determined on the basis of the number of kinds of color-sensitivity characteristics of the light-sensitive pixels included in the partial column set, and in which a matrix in which the number of light-sensitive pixels Wⱼₖ, which are included in the partial column Fⱼ and of which the color-sensitivity characteristics correspond to a k-th color (1≦k≦L), is established as a component of the j-th line and k-th column is a regular matrix.

When the solid-state image pickup device is used for additively synthesizing information charges of αs-th to (αe-th lines (αs<αe) in the light-sensitive pixel array during an additive synthesis process, the columns within the range of lines, that is, the (αe−αs+1) pixel columns corresponding to the number of lines, constitute the partial columns, respectively. The partial column set is a group including the partial columns positioned within the range of lines and is defined every partial column. It is supposed that the number of kinds of color-sensitivity characteristics of the light-sensitive pixel array is ρ. ρ is determined in accordance with, for example, the number of colors of the color filter fitted to the solid-state image pickup device. Most color filters have, for example, three colors of R, G and B, and in this case, ρ=3. However, any number of colors of two or more kinds may be applied to the present invention, and thus ρ is an integer larger than or equal to 2. When a partial column includes ρ kinds of color-sensitivity characteristics, that is, the light-sensitive pixels of all the kinds of colors, the number of partial columns L constituting the partial column set for the partial column is ρ. On the other hand, when a partial column includes the light-sensitive pixels of the number of colors ρ′ less than ρ, L may become a value larger than ρ′. This is because L is set to the maximum number of colors of the partial columns constituting the partial column set. L partial columns Fⱼ constituting the partial column set satisfy a condition (Condition I) that a square matrix of L lines and L columns having the number of light-sensitive pixels Wⱼₖ (k is an index corresponding to kinds of colors) every color-sensitivity characteristic of the respective partial column Fⱼ as a component of the j-th line and the k-th column is a regular matrix and a condition (Condition II) that the partial columns as constituent elements have a predetermined positional relation in the line direction each other. In other words, when the arrangement of light-sensitive pixels having different color-sensitivity characteristics within a predetermined range of lines (αs-th to αe-th lines) in the light-sensitive pixel array is determined, it is considered that a partial column set satisfying Condition I and Condition II exists every partial column. Condition I means that an inverse matrix exists for the square matrix, and from this condition, it is guaranteed to solve the simultaneous linear equation expressed by the following expression (10). Condition II guarantees the horizontal resolution. The width of the line direction of the partial column set in the light-sensitive pixel array has an influence on the horizontal resolution of the image signals every color component obtained on the basis of the partial column set. By allowing the partial columns Fⱼ constituting the partial column set to have a predetermined positional relation in the line direction, it is possible to make the width of the partial column set constant for any partial column, so that it is possible to uniform the resolution at all the points in the horizontal direction. In addition, the width of the partial column set is determined in accordance with an allowable horizontal resolution. Since the vertical resolution is determined in accordance with the length of the partial columns, it is possible to uniform the horizontal and vertical resolutions by determining the width of the partial column set in accordance with the length of the partial columns.

According to another aspect of the present invention, there is provided an image signal processor for receiving a color-mixed image signal obtained by additively synthesizing respective lines within the predetermined range of line numbers in a column direction in the solid-state image pickup device and for generating an image signal for each color component on the basis of the color-mixed image signal, the image signal processor comprising a color component calculating portion, in which the color component calculating portion acquires a synthesized signal value Sⱼ for each partial column Fⱼ (1≦j≦L) constituting the partial column set on the basis of the image signal obtained by the additive synthesis, and calculates Cₖ (1≦k≦L) satisfying a simultaneous linear equation expressed by the following equation (10) as an image signal value of a k-th color at a sampling point corresponding to a position of the partial column set in the light-sensitive pixel array.

$${S}_{j} = {\sum }_{k = 1}^{L} {w}_{jk} {C}_{k } ( 1 ≦ j ≦ L ) \qquad ( 10 )$$

According to another aspect of the present invention, there is provided a solid-state image pickup device, in which in a (2n−1)th column and a (2n+1)th column (n≧1) of the light-sensitive pixel array, the light-sensitive pixels of which the color-sensitivity characteristic corresponds to a first color and the light-sensitive pixels of which the color-sensitivity characteristic corresponds to a second color are alternately arranged and the arrangement cycles of the color-sensitivity characteristics are staggered in a column direction from each other, and in which, in a 2n-th column and a (2n+2)th column of the light-sensitive pixel array, the light-sensitive pixels of which the color-sensitivity characteristic corresponds to the first color and the light-sensitive pixels of which the color-sensitivity characteristic correspond to a third color are alternately arranged and the arrangement cycles of the color-sensitivity characteristics are staggered in the column direction from each other.

According to another aspect of the present invention, there is provided an image signal processor for receiving a color-mixed image signal obtained by additively synthesizing respective lines within a predetermined range of odd line numbers in a column direction in the solid-state image pickup device and for generating an image signal for each color component on the basis of the color-mixed image signal, the image signal processor comprising a color component calculating portion, in which the color component calculating portion acquires a synthesized signal S_{O1} for the partial columns F_{O1} positioned within the predetermined range of lines in the (2n−1)th column (n≧1) of the light-sensitive pixel array, a synthesized signal S_{O2} for the partial columns F_{O2} positioned within the predetermined range of lines in the (2n+1)th column, a synthesized signal S_{E1} for the partial columns F_{E1} positioned within the predetermined range of lines in the 2n-th column, and a synthesized signal S_{E2} for the partial columns F_{E2} positioned within the predetermined range of lines in the (2n+2)th column, on the basis of the image signal obtained by the additive synthesis, calculates C_{Ok} (k=1 or 2) satisfying a simultaneous linear equation expressed by the following equation (11) as image signal values of the k-th color at sampling points corresponding to positions of the partial column F_{O1} and the partial column F_{O2} in the light-sensitive pixel array by setting the numbers of light-sensitive pixels corresponding to the first color included in the partial column F_{O1} and the partial column F_{O2} to W_{O11} and W_{O21} and setting the numbers of light-sensitive pixels corresponding to the second color to W_{O12} and W_{O22},

$${S}_{oj} = {\sum }_{k = 1 , 2}^{} {w}_{Ojk} {C}_{Ok} ( j = 1 , 2 ) \qquad ( 11 )$$

and calculates C_{Ek} (k=1 or 3) satisfying a simultaneous linear equation expressed by the following equation (12) as image signal values of the k-th color at sampling points corresponding to positions of the partial column F_{E1} and the partial column F_{E2} in the light-sensitive pixel array by setting the numbers of light-sensitive pixels corresponding to the first color included in the partial column F_{E1} and the partial column F_{E2} to W_{E11} and W_{E21} and setting the numbers of light-sensitive pixels corresponding to the third color to W_{E13} and W_{E23}, respectively,

$${S}_{Ej} = {\sum }_{k = 1 , 3}^{} {w}_{Ejk} {C}_{Ek} ( j = 1 , 2 ) \qquad ( 12 )$$

### BRIEF DESCRIPTION OF THE DRAWINGS

FIG. 1 is a schematic diagram illustrating an arrangement of a bayer-type color filter;

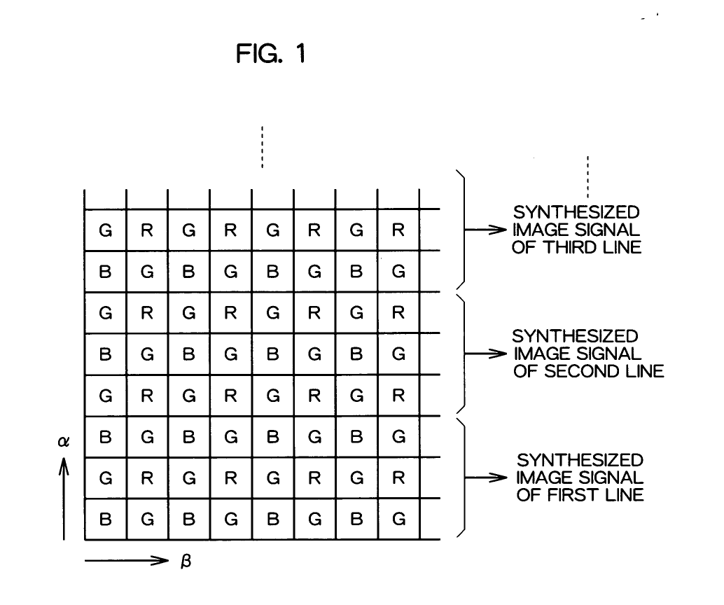

FIG. 2 is a block diagram schematically illustrating a construction of an image pickup device according to the present invention;

FIG. 3 is a schematic diagram illustrating a color filter arrangement according to a first embodiment of the present invention;

FIG. 4 is a schematic diagram illustrating a first color filter arrangement according to a second embodiment of the present invention; and

FIG. 5 is a schematic diagram illustrating a second color filter arrangement according to the second embodiment of the present invention.

### DESCRIPTION OF THE PREFERRED EMBODIMENTS

Now, embodiments of the present invention (hereinafter, referred to as embodiments) will be described with reference to the drawings.

### First Embodiment

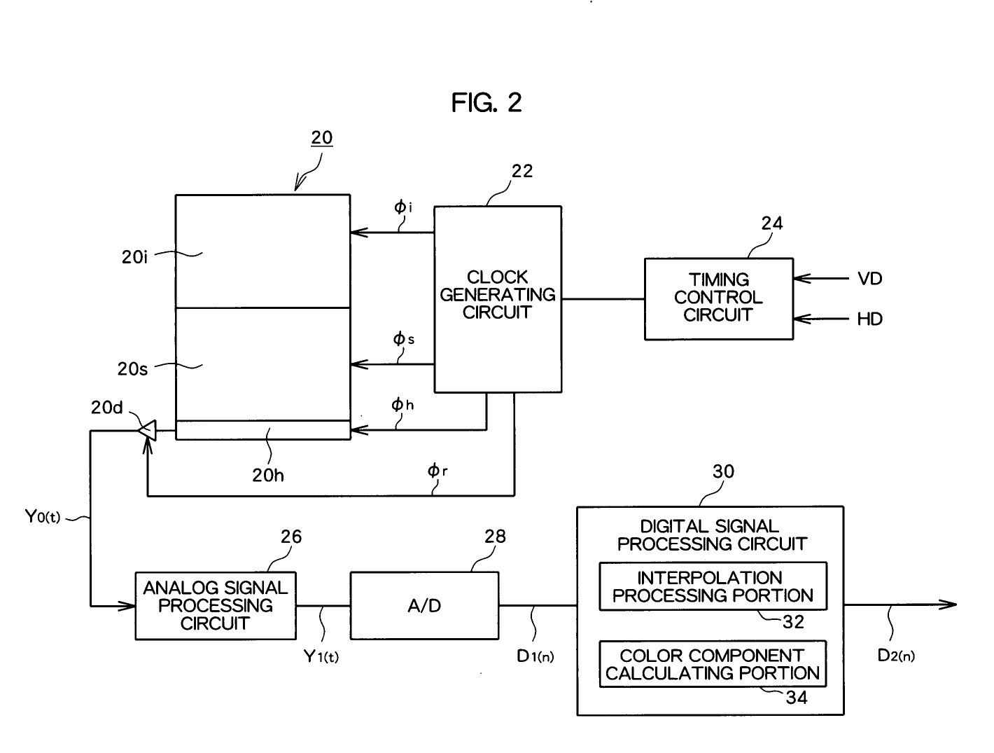

FIG. 2 is a block diagram schematically illustrating a construction of an image pickup device employing a CCD image sensor according to the present invention. The image pickup device comprises a CCD image sensor 20, a clock generating circuit 22, a timing control circuit 24, an analog signal processing circuit 26, an A/D conversion circuit 28, and a digital signal processing circuit 30. The image pickup device also comprises a mechanical shutter not shown in the front of an imaging portion 20i.

The CCD image sensor 20 is a frame transfer type and comprises an imaging portion 20i, a storage portion 20s, a horizontal transfer portion 20h, and an output portion 20d, which are formed on the surface of a semiconductor substrate. The image sensor 20 is used, for example, for photographing a still picture with a high resolution using the overall cells of the imaging portion 20i. On the other hand, the image sensor is also used for displaying a picture on a preview screen or photographing a moving picture, which does not require a high resolution.

In the imaging portion 20i, the plural cells (pixels) generating electric charges (information charges) corresponding to the incident light quantity are arranged in a matrix shape. A color filter is fitted to the imaging portion 20i, thereby giving color-sensitivity characteristics to the respective cells. Each column of cells arranged in a matrix shape in the imaging portion 20i constitutes a vertical CCD shift register. The vertical CCD shift registers of the imaging portion 20i comprise gate electrodes disposed plurally in the line direction on the substrate and the accumulation and the vertical transfer of information charges in the imaging portion 20i are controlled with three-phase clock φi applied to the gate electrodes.

The storage portion 20s is covered with a light-shielding layer, thereby preventing the generation of electric charges due to incidence of light. The storage portion 20s comprises vertical CCD shift registers arranged plurally in the line direction. The vertical CCD shift registers of the storage portion 20s are provided to correspond to the respective vertical CCD shift registers of the imaging portion 20i. In the corresponding vertical CCD shift registers of the imaging portion 20i and the storage portion 20s, since a channel continuously extends, the information charges accumulated in the imaging portion 20i can be transferred to the storage portion 20s by driving both shift registers in synchronism with each other. Incidentally, the vertical CCD shift registers of the storage portion 20s have the number of bits corresponding to at least ⅓ of the number of lines of the imaging portion 20i for the reason described later. The vertical CCD shift registers of the storage portion 20s comprise plural gate electrodes disposed in the line direction, similarly to the imaging portion 20i and the storage and the vertical transfer of the information charges in the storage portion 20s are controlled with three-phase clock φs applied to the gate electrodes.

If set exposure time passes, the information charges accumulated in the imaging portion 20i are vertically transferred to the horizontal transfer portion 20h through the storage portion 20s. The horizontal transfer portion 20h sequentially transfers the information charges transferred in a unit of line from the storage portion 20s to the output portion 20d in response to a horizontal transfer clock φh applied to the plural gate electrodes. The output portion 20d comprises an electrically-independent capacitor and an amplifier for taking out potential variation thereof, and receives the information charges outputted from the horizontal transfer portion 20h with the capacitor in a bit unit, converts the information charges into a voltage value, and then outputs the voltage value as a time-series image signal.

When a still picture is photographed with the image sensor 20, the exposure time is adjusted by opening and closing the mechanical shutter, and when the accumulated information charges are transferred through the vertical CCD shift registers of the imaging portion 20i, generation of smear is prevented by closing the mechanical shutter. When the mechanical shutter is closed, the clock generating circuit 22 allows the information charges accumulated in the imaging portion 20i to be vertically transferred in a line unit to the horizontal transfer portion 20h by synchronizing and driving φi and φs. The information charges transferred in a line unit to the horizontal transfer portion 20h are sequentially outputted to the output portion 20d with the horizontal transfer clock φh generated from the clock generating circuit 22.

On the other hand, since a higher frame rate is required for the previewing and the moving picture photographing than the still picture photographing, the opening and closing operation of the mechanical shutter is frequently carried out, thereby increasing the power consumption. Therefore, in this case, with the mechanical shutter opened, the clock generating circuit 22 performs the frame transfer to the storage portion 20s from the imaging portion 20i when the exposure time passes. In order to enable the photographing at a high frame rate, the clock generating circuit 22 drives the image sensor 20 to additively synthesize and read out plural lines, at the time of the preview or the moving picture photographing. As a result, since the number of driving times of the horizontal transfer portion 20h is decreased, the frame rate can be enhanced. The additive synthesis of plural lines is performed at the time of the charge transfer from the imaging portion 20i to the storage portion 20s. In this embodiment, the operation of adding the information charges of three lines into the information charges of one line is performed. In the operation, in the course of vertically transferring the information charges of three lines to the storage portion 20s from the imaging portion 20i, the driving of the storage portion 20s is stopped and the information charges of three lines are stored in a line of the storage portion 20s close to the imaging portion 20i. That is, the clock generating circuit 22 drives one cycle of the clock φs corresponding to three cycles of the clock φi, whereby three lines of the imaging portion 20i are synthesized during the transfer to the storage portion 20s and the synthesized information charges stored in the respective lines of the storage portion 20s are vertically transferred by one line whenever the synthesis of three lines is completed. The synthesized information charges are transferred in a line unit to the horizontal transfer portion 20h from the storage portion 20s and are sequentially outputted to the output portion 20d from the horizontal transfer portion 20h with the horizontal transfer clock φh generated from the clock generating circuit 22.

The storage portion 20s is provided to temporarily store the information charges transferred in a frame unit from the imaging portion 20i at the time of the preview and the moving picture photographing in which the mechanical shutter is not used. That is, the storage portion 20s is not particularly required for the still picture photographing using the mechanical shutter and the information charges of three lines are additively synthesized into one line during the transfer to the storage portion 20s in a case of the preview and the moving picture photographing, so that the minimum number of bits of the vertical shift registers constituting the storage portion 20s can be established to ⅓ of the number of bits of the vertical shift registers constituting the imaging portion 20i.

The timing control circuit 24 generates various timing signals for the respective portions of the image pickup device on the basis of the vertical synchronization signal VD and a horizontal synchronization signal HD. The clock generating circuit 22 also generates various clocks such as φi, φs, or φh on the basis of the timing signals supplied from the timing control circuit 24.

The analog signal processing circuit 26 receives the image signals Y0(t) outputted from the CCD image sensor 20 and performs various analog signal processes such as sample hold, gain adjustment, etc. to the image signals. The A/D conversion circuit 28 receives the image signals Y1(t) subjected to the analog signal processes, converts the image signals into digital signals every pixel, and outputs the digital signals as the image data D1(n).

The digital signal processing circuit 30 generates brightness data or color data from the image data D1(n), also performs the outline correction, the gamma correction, etc. to the generated data, and then outputs image data D2(n). The digital signal processing circuit 30 has an interpolation processing portion 32 for performing an interpolation process. In the color filter arranged in a mosaic shape, the same colors are discretely arranged in the light-sensitive pixel array. For this reason, the image data D1(n) corresponding to the same color are obtained from the points spaced in the line direction and the column direction among the two-dimensionally arranged sampling points. The interpolation processing portion 32 performs the interpolation process on the basis of the image data D1(n) of the same color defined at the discrete points and generates the image data of the corresponding color at the spaced sampling points. By performing this process to the respective colors, the component values of the respective colors at the respective sampling points are defined in the image data D2(n) outputted from the digital signal processing circuit 30.

The digital signal processing circuit 30 has a color component calculating portion 34. Since the additive synthesis of three lines is performed in the case of the preview or the moving picture photographing described above, the image signals having plural colors mixed are outputted from the image sensor 20. The color component calculating portion 34 performs operation of separating the respective color component signals from the image data D1(n) into which plural color components are mixed. The operation will be described later.

The interpolation process in a case of the still picture photographing will be described. At the time of the still picture photographing, the information charges of each line obtained by the imaging portion 20i are transferred in a line unit to the horizontal transfer portion 20h as they are, and the information charges of one pixel of the imaging portion 20i are stored in the respective bits of the horizontal transfer portion 20h. By horizontally driving the horizontal transfer section 20h, the image signals corresponding to the information charges of the respective pixels are outputted from the output portion 20d. That is, the image data D1(n) at the time of the still picture photographing are determined by the information charges of one pixel of the imaging portion 20i, which means that the image data D1(n) includes only one color component of the constituent colors of the color filter. Therefore, at the time of photographing still pictures, the component values of the respective colors at the respective sampling points can be determined basically by performing the interpolation process directly to the image data D1(n) of a single color component. That is, the color component calculating portion 34 is not used for the processes at the time of photographing still pictures.

On the other hand, at the time of the preview or the moving picture photographing, as described above, the information charges of three pixels disposed in the column direction are additively synthesized and outputted from the output portion 20d. In the color filter arranged in a mosaic shape, since the three pixels disposed in the column direction usually include pixels of plural colors, the image data D1(n) include plural color components. For this reason, the digital signal processing circuit 30 first calculates the color components included in the image data D1(n) with the color component calculating portion 34, and then performs the interpolation process to the color component signals with the interpolation processing portion 32.

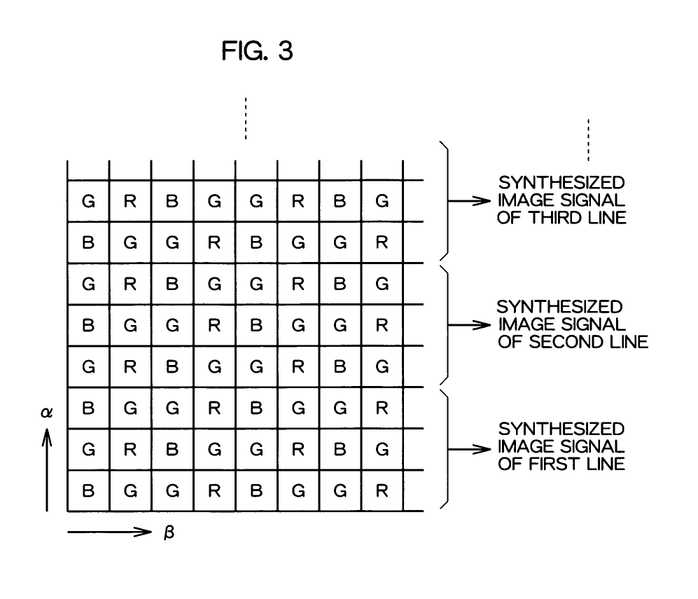

Now, operation of the color component calculating portion 34 in the image pickup device will be described. The imaging portion 20i of the image sensor 20 has a color filter having the arrangement shown in FIG. 3 and the color component calculating portion 34 performs a process corresponding to the color filter having the arrangement. In the color filter shown in FIG. 3, a line number α is sequentially numbered from the line closest to the storage portion 20s (or the horizontal transfer portion 20h) in the imaging portion 20i and a column number β is sequentially numbered from the column closet to the output portion 20d. The color filter shown in FIG. 3 comprises, for example, three colors of R, G, and B, G and B are alternately arranged in each odd column of the light-sensitive pixel array, and the arrangement cycles of G and B in two odd columns adjacent to each other are deviated by one pixel in the column direction. R and G are alternately arranged in each even column of the light-sensitive pixel array, and the arrangement cycles of R and G in two even columns adjacent to each other are deviated by one pixel in the column direction. In this arrangement, a color (color-sensitivity characteristic) C(α, β) of a light-sensitive pixel PX(α, β) specified by the line number α and the column number β is expressed by the following equations.
C(2λ−1, 4μ−3)=C(2λ, 4μ−1)=B
C(2λ−1, 4μ)=C(2λ, 4μ−2)=R
C(2λ−1, 4μ−2)=C(2λ−1, 4μ−1)=C(2λ, 4μ−3)=C(2λ, 4μ)=G (where λ and μ are natural numbers) (13)

The CCD image sensor 20 mounted with the color filter performs the additive synthesis operation of three lines at the time of the preview or the moving picture photographing. As a result, the synthesized image signals of the a-th line (a≧1) outputted from the CCD image sensor 20 is obtained by synthesizing the information charges of the (3a−2)th to 3a-th lines of the imaging portion 20i.

Hereinafter, the signal values corresponding to the pixels PX(α, β) of the imaging portion 20i are indicated by symbols R(α, β), G(α, β) and B(α, β) corresponding to the colors R, G, and B of the pixels, and the image signal values corresponding to the b-th line of the imaging portion 20i among the output image signals of the a-th line outputted from the CCD image sensor are indicated by a symbol D(a, b).

The following four kinds of image signal values D having different color-mixture ratios are included in the odd-line output among the image signals obtained by additively synthesizing three lines in the image sensor 20. The image signal values are extracted as the image data D1(n) in accordance with the output values and are inputted to the digital signal processing circuit 30.
D(2λ−1, 4μ−3)=B(6λ−5, 4μ−3)+G(6λ−4, 4μ−3)+B(6λ−3, 4μ−3) (14)
D(2λ−1, 4μ−2)=G(6λ−5, 4μ−2)+R(6λ−4, 4μ−2)+G(6λ−3, 4μ−2) (15)
D(2λ−1, 4μ−1)=G(6λ−5, 4μ−1)+B(6λ−4, 4μ−1)+G(6λ−3, 4μ−1) (16)
D(2λ−1, 4μ)=R(6λ−5, 4μ)+G(6λ−4, 4μ)+R(6λ−3, 4μ) (17)
(where λ and μ are natural numbers)

The following four kinds of image signal values D of which the color-mixture ratios are different from each other are included in the even-line output obtained by the additive synthesis of three lines, and the image signal values are extracted as the image data D1(n) in accordance with the output values and are inputted to the digital signal processing circuit 30.
D(2λ, 4μ−3)=G(6λ−2, 4μ−3)+B(6λ−1, 4μ−3)+G(6λ−1, 4μ−3) (18)
D(2λ, 4μ−2)=R(6λ−2, 4μ−2)+G(6λ−1, 4μ−2)+R(6λ, 4μ−2) (19)
D(2λ, 4μ−1)=B(6λ−2, 4μ−1)+G(6λ−, 4μ−1)+B(6λ, 4μ−1) (20)
D(2λ, 4μ)=G(6λ−2, 4μ)+R(6λ−1, 4μ)+G(6λ, 4μ) (21)
(where λ and μ are natural numbers)

D1(n) input to the digital signal processing circuit 30 is sent to the color-component calculating portion 34. The color-component calculating portion 34 combines two data pieces (D(a, b) and D(a, b+2)) with one column therebetween among the image data D1(n), and calculates the color component signal values at the sampling point P(a, b) corresponding to the position of a pixel area R having six pixels, where the signal values are synthesized into the two data pieces. As can be seen from the expressions (14) to (21), D(a, b) and D(a, b+2) comprises the same two kinds of color components (indicated by Cx and Cy), respectively. The color component calculating portion 34 represents the values of the colors Cx and Cy in the pixel area R with the spatially-constant values <Cx> and <Cy> and calculates the values <Cx> and <Cy> as the color component signal values of the pixel area R. The calculating expressions are expressed as follows.
<Cx>=[2D(a, b)−D(a, b+2)]/3 (22)
<Cy>=[2D(a, b+2)−D(a, b)]/3 (23)
Here, in processing the odd output line (that is, a=2λ−1),
(i)<Cx> and <Cy> give <B> and <G> to the data group corresponding to b=4μ−3, respectively,
(ii) <Cx> and <Cy> give <G> and <R> to the data group corresponding to b=4μ−2, respectively,
(iii) <Cx> and <Cy> give <G> and <B> to the data group corresponding to b=4μ−1, respectively, and
(iv) <Cx> and <Cy> give <R> and <G> to the data group corresponding to b=4μ, respectively.

In addition, in processing the even output line (that is, a=2λ),
(v) <Cx> and <Cy> give <G> and <B> to the data group corresponding to b=4μ−3, respectively,
(vi) <Cx> and <Cy> give <R> and <G> to the data group corresponding to b=4μ−2, respectively,
(vii) <Cx> and <Cy> give <B> and <G> to the data group corresponding to b=4μ−1, respectively, and
(viii) <Cx> and <Cy> give <G> and <R> to the data group corresponding to b=4μ, respectively.

For example, in a case of (i), the expressions (22) and (23) are obtained from the following expressions in which the G signal value and the B signal value of the respective pixels in the right sides of the expressions (14) and (16) are substituted with the representative values <G> and <B>. Incidentally, the following expressions correspond to the expression (11).
D(2λ−1, 4μ−3)=<G>+2<B> (24)
D(2λ−1, 4μ−1)=2<G>+<B> (25)

Here, the expressions (24) and (25) are linear simultaneous equations of <G> and <B>, and the expressions (22) and (23) are solutions thereof.

The same is true of the other cases of (ii) to (viii), and thus the expressions (22) and (23) are obtained from two expressions corresponding to D(a, b) and D(a, b+2) among the data values expressed by the expressions (14) to (21).

As described above, the operation of additively synthesizing and reading out the plural lines is used to secure the frame rate at the time of preview or the moving picture photographing. The number of added lines is basically determined not to decrease the vertical resolution lower than needed, on the basis of a condition given in view of a resolution of a display unit of the preview screen, a resolution required for the moving picture and so on or a condition given in view of the required frame rate.

On the other hand, in the process of separating color components from the image data obtained by additively synthesizing the lines in this embodiment and the conventional art, the synthesized image data are plurally combined and the respective color component values smoothed in the pixel area R corresponding to the synthesized image data are calculated. The smoothing in the color separation process is a factor of decreasing the resolution other than the additive synthesis of lines. For example, when plural data used for the color separation process are acquired from the plural lines of the synthesized image signal, the vertical size of the pixel area R is expanded more than the number of added lines. For this reason, the vertical resolution of the image formed with the color component signals obtained through the color separation process is more deteriorated than that due to the additive synthesis of lines.

On the contrary, in the present invention, the color component signals at the sampling point P(a, b) are calculated using the data D(a, b) and D(a, b+2) belonging to the same line of the synthesized image signal. That is, in the present invention, the vertical size and range of the pixel area R coincide with those of the lines to be added. For this reason, even when the color separation process is performed, the vertical resolution is not deteriorated more than that due to the additive synthesis of lines. Furthermore, by allowing the vertical size and the horizontal size of the pixel area R to be substantially equal each other, the vertical resolution and the horizontal resolution can be balanced.

In the processing method of acquiring data from the plural lines of the synthesized image signal, first of all, a line memory for storing the synthesized image signals outputted from the image sensor 20 is necessary. On the contrary, in the processing method according to this embodiment, the image data D(a, b) which are advanced by two pixels in the same line as the image data D(a, b+2) obtained most recently are used as the synthesized image signal for the processing. Therefore, in this embodiment, with a one-pixel register for storing the image data D(a, b) combined into the image data D(a, b+2) obtained most recently and a one-pixel register for storing the image data D(a, b+1) combined into the image data D(a, b+3) obtained next, the color separation process can be basically performed.

As described above, by the color component calculating portion 34, <G>(≡<G>_{2η-1}) and <B>(≡<B>_{2η-1}) are calculated about the respective sampling points P(a, 2η−1) of the odd columns and <R>(≡<R>_{2η}) and <G>(≡<G>_{2η}) are calculated about the respective sampling points P(a, 2η) of the even columns. The output of the color-component calculating portion 34 is sent to the interpolation processing portion 32.

The interpolation processing portion 32 calculates the color component value of the lack kinds about the respective sampling points by performing the interpolation process in the horizontal direction. As a result, the respective color component values of R, G and B are calculated about the respective sampling points. Here, as the interpolation process, a (1, 2, 1) filtering process is performed in the horizontal direction at the respective sampling points. The filtering process is expressed by the following expression. Here, <<R>>_{ξ}, <<G>>_{ξ} and <<B>>_{ξ} indicate R, G and B values as a processing result at the sampling point P(a, ξ), and R_{ζ}, G_{ζ} and B_{ζ} (ζ=ξ−1, ξ, ξ+1) indicate R, G and B values calculated about the sampling point P(a, ζ) by the color component calculating portion 34.
<<R>>_{ξ}=(R_{ξ-1}+2R_{ξ}+R_{ξ+1})/2 (26)
<<B>>_{ξ}=(B_{ξ-1}+2B_{ξ}+B_{ξ+1})/2 (27)
<<G>>_{ξ}=(G_{ξ-1}+2G_{ξ}+G_{ξ+1})/4 (28)

Here, for the G component, G_{ξ-1}=<G>_{ξ-1}, G_{ξ}=<G>_{ξ}, and G_{ξ+1}=<G>_{ξ+1}. On the other hand, for the R and B components, when ξ is an odd number, R_{ξ-1}=<R>_{ξ-1}, R_{ξ+1}=<R>_{ξ+1}, B_{ξ}=<B>_{ξ}, and R_{ξ}=B_{ξ-1}=B_{ξ+1}=0, and when ξ is an even number, B_{ξ-1}=<B>_{ξ-1}, B_{ξ+1}=<B>_{ξ+1}, R_{ξ=<R>}_{ξ, and B}_{ξ}=R_{ξ-1}=R_{ξ+1}=0. Therefore, the interpolation processing portion 32 outputs the followings about the sampling points in the odd columns:
<<R>>_{ξ}=(<R>_{ξ-1}+<R>_{ξ+1})/2 (29)
<<B>>_{ξ}=<B>_{ξ} (30)
<<G>>_{ξ}=(<G>_{ξ-1}+2<G>_{ξ}+<G>_{ξ+1})/4 (31), and
outputs the followings about the sampling points in the even columns:
<<R>>_{ξ}=<R> (32)
<<B>>_{ξ}=(<B>_{ξ-1}+<B>_{ξ+1})/2 (33)
<<G>>_{ξ}=(<G>_{ξ-1}+2<G>_{ξ}+<G>_{ξ+1})/4 (34)

The digital signal processing circuit 30 further performs the signal processing and generates and outputs the image data D2(n), using the output of the interpolation processing portion 32 as needed.

In the aforementioned construction, although it has been described that the additive synthesis of three lines is performed to the arrangement of the color filter shown in FIG. 3, the synthesized image signal may be similarly divided into the constituent color components in a case where the five or more odd lines are additively synthesized.

### Second Embodiment

In the first embodiment, the color components are separated from the data values D(a, b1) and D(a, b2) at two sampling points P(a, b1) and P(a, b2) of the synthesized image signal of the a-th line obtained through the line addition. Here, the data values D(a, b1) and D(a, b2) have two kinds of color components Cx and Cy, two pixels of Cx and one pixel of Cy are synthesized into D(a, b1), and one pixel of Cx and two pixels of Cy are synthesized into D(a, b2). If the signal values of the respective pixels are substituted with the representative values <Cx> and <Cy>, the following linear simultaneous equations of two elements based on <Cx> and <Cy> are obtained:
D(a, b1)=2<Cx>+<Cy> (35)
D(a, b2)=<Cx>+2<Cy> (36)
As solutions for the above equations, the following expressions corresponding to the expressions (22) and (23) are obtained:
<Cx>=[2D(a, b1)−D(a, b2)]/3 (37)
<Cy>=[2D(a, b2)−D(a, b1)]/3 (38)

The following details can be seen from the color separation process of the first embodiment. In order to calculate L kinds of color components on the basis of the data obtained about the plural sampling points of the synthesized image signal of the a-th line, the data values D(a, bj) of L sampling points P(a, bj) (1≦j≦L) should be acquired. Then, for each of the L data values, the signal components of respective pixels included in the corresponding data value are substituted with a representative value <Cₖ>(1≦k≦L) corresponding to the color of the corresponding pixel, thereby obtaining the following L expressions.

$$D ( a , {b}_{j} ) = {\sum }_{k = 1}^{L} {w}_{jk} \cdot 〈 {C}_{k} 〉 ( 1 ≦ j ≦ L ) \qquad ( 39 )$$

The expression (39) constitutes a linear simultaneous equation of L elements based on <Cₖ>, and the solution thereof means the color component signal at the sampling point corresponding to the pixel area R having a group of pixels constituting the L data values D(a, bj).

A necessary and sufficient condition under which the simultaneous equation (39) can have a solution is that a L×L matrix having the number of light-sensitive pixels Wⱼₖ indicated by coefficients of the right side in the expression (39) as a component of the j-th line and k-th column is a regular matrix (Condition I). When this condition is satisfied, the color component signals corresponding to the pixel area R are obtained.

As the line-direction size of the pixel area R is decreased, the horizontal resolution basically becomes better. Therefore, it is required that the L data values D(a, bj) satisfying Condition I are obtained from the sampling points P(a, bj) having a close positional relation (Condition II).

The CCD image sensor according to this embodiment comprises a color filter in which the respective pixel areas R plurally established in the line direction satisfy Condition I and Condition II for each line set including plural lines to be added.

Here, basic constructions of the CCD image sensor and the image pickup device are substantially equal to those of the first embodiment. Accordingly, the same elements are denoted by the same reference symbols and are referred to FIG. 2.

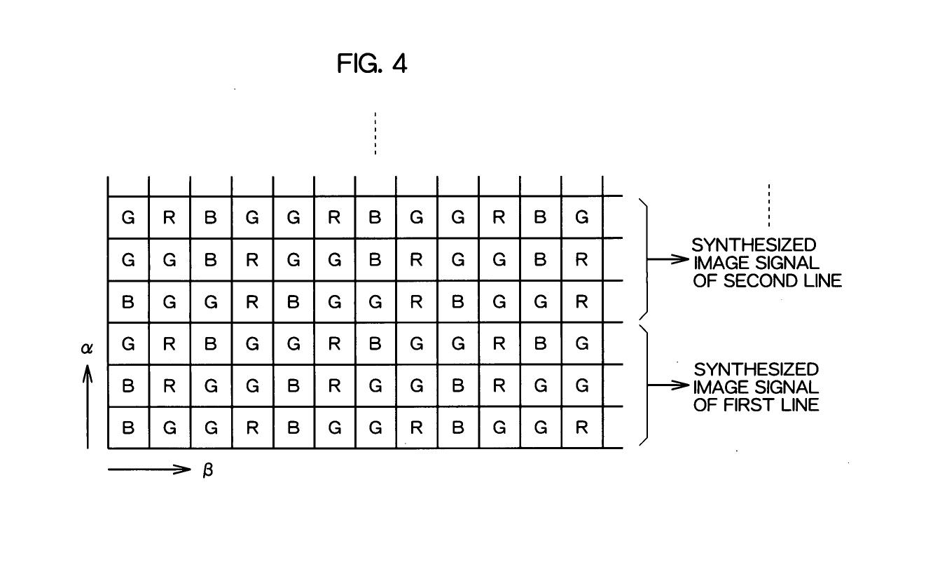

FIG. 4 is a schematic diagram illustrating a first color filter arrangement according to the second embodiment of the present invention. In this figure, the line number a and the column number β are numbered similarly to the color filter shown in FIG. 3. In the CCD image sensor 20 fitted with the color filter, in a case of the preview or the moving picture photographing, the information charges accumulated in the imaging portion 20i are additively synthesized in a unit of three lines and the synthesized image signals are outputted from the output portion 20d. Here, the (3a−2)th to 3a-th lines of the imaging portion 20i are added to generate the synthesized image signal of the a-th line.

The image data D1(n) generated from the synthesized image signal are sent to the color component calculating portion 34. The color component calculating portion 34 combines two data D(a, b) and D(a, b+2) with one line therebetween among the image data D1(n). The two data have two kinds of color components Cx and Cy (R and G or G and B) common thereto, respectively, and give the following simultaneous equations of two elements through the expression (39).
D(a, b)=2<Cx>+<Cy> (40)
D(a, b+2)=<Cx>+2<Cy> (41)

As can be clearly seen from comparison of the expressions (40) and (41) with the expressions (35) and (36), on the basis of the two data D(a, b) and D(a, b+2) obtained from the color filter of FIG. 4, the component signal values <Cx> and <Cy> of Cx and Cy at the corresponding pixel area R (sampling point P(a, b)) can be calculated. Incidentally, since W₁₁=W₂₂=2, W₁₂=W₂₁=1 can be seen from coefficients of the respective terms of the right sides in the expressions (40) and (41) and the 2×2 matrix having Wⱼₖ as the component of the j-th line and the k-th column does not have the determinant of 0, the matrix is a regular matrix.

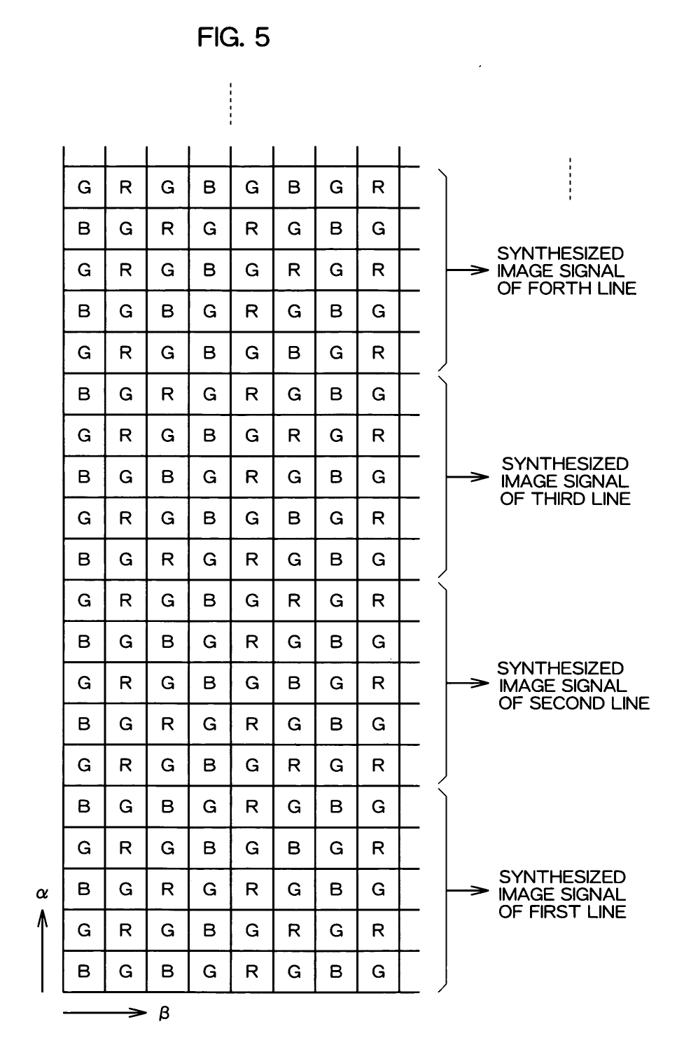

FIG. 5 is a schematic diagram illustrating a second color filter arrangement according to the second embodiment of the present invention. In FIG. 5, the line number α and the column number β are numbered similarly to the respective color filters. The arrangement of the color filter is expressed by the following equation with the color C(α, β) of the light-sensitive pixel PX (α, β) specified by the line number α and the column number β.
C(2λ, 6μ−2)=C(2λ−1, 6μ−5)=C(4λ−3, 6μ−3)=C(4λ, 6μ)=B
C(2λ, 6μ−4)=C(2λ−1, 6μ−1)=C(4λ−1, 6μ−3)=C(4λ−2, 6μ)=R
C(2λ, 2μ−1)=C(2λ−, 2μ)=G (where λ and μ are natural numbers) (42)

In the CCD image sensor 20 fitted with the color filter, in a case of the preview or the moving picture photographing, the information charges accumulated in the imaging portion 20i are additively synthesized, for example, by five lines and the synthesized image signals are outputted from the output portion 20d. For example, the (5a−4)th to 5a-th lines of the imaging portion 20i are added to generate the synthesized image signal of the a-th line.

In order to calculate the color component signal at the sampling point P(a, b), the color component calculating portion 34 combines three continuous data D(a, b), D(a, b+1), D(a, b+2) (b>1) of the image data D1(n) of the a-th line generated from the synthesized image signal. For example, at the sampling point P(a, 1), that is, in a case of b=1, the three data provide the following simultaneous equation of three elements corresponding to the expression (39).
D(a, b)=2<G>+3<B> (43)
D(a, b+1)=2<R>+3<G> (44)
D(a, b+2)=<R>+2<G>+2<B> (45)

Since the 3×3 matrix (coefficient matrix) including coefficients of all the terms in the right sides of the expressions (43) to (45) does not have a determinant of 0 and thus is a regular matrix, the simultaneous equation of three elements has a solution. The color component calculating portion 34 calculates the solutions <R>, <G>, and <B> of the simultaneous equation and outputs the solutions as the color component signals at the sampling point P (a, b).

The three-element simultaneous equation obtained on the basis of the data D(a, b), D(a, b+1), and D(a, b+2) is periodically (at a period of 4) changed in accordance with the value of a and is also periodically (at a period of 6) changed in accordance with b, but all coefficient matrixes corresponding to the equations for all groups of a and b are regular matrixes. Therefore, the color component calculating portion 34 can calculate the color component signals of R, G, and B at the respective sampling points P(a, b) on the basis of three data values for the respective values of b.

1. A solid-state image pickup device comprising a light-sensitive pixel array in which a plurality of light-sensitive pixels each having a different color-sensitivity characteristic are arranged in a matrix shape, a plurality of vertical shift registers for vertically transferring a plurality of information charge packets generated from columns of the light-sensitive pixels for every column, and a horizontal shift register for horizontally transferring and outputting the plurality of information charge packets transferred by one line from the plurality of vertical shift registers,
wherein for each partial column positioned within a predetermined range of lines to be subjected to an additive synthesis in a column direction among the light-sensitive pixel columns, a partial column set including L (L≧2) partial columns Fj (1≦j≦L) which include each partial column and have a predetermined positional relation in a line direction is defined,
wherein the number of partial columns L included in the partial column set is determined on the basis of the number of kinds of color-sensitivity characteristics of the light-sensitive pixels included in the partial column set, and
wherein a matrix in which the number of light-sensitive pixels Wⱼₖ, which are included in the partial column Fⱼ and of which the color-sensitivity characteristics correspond to a k-th color (1≦k≦L), is established as a component of j-th line and k-th column is a regular matrix.

2. A solid-state image pickup device comprising a light-sensitive pixel array in which a plurality of light-sensitive pixels each having a different color-sensitivity characteristic are arranged in a matrix shape, a plurality of vertical shift registers for vertically transferring a plurality of information charge packets generated from columns of the light-sensitive pixels for every column, and a horizontal shift register for horizontally transferring and outputting the plurality of information charge packets transferred by one line from the plurality of vertical shift registers,
wherein in a (2n−1)th column and a (2n+1)th column (n≧1) of the light-sensitive pixel array, the light-sensitive pixels of which the color-sensitivity characteristic corresponds to a first color and the light-sensitive pixels of which the color-sensitivity characteristic corresponds to a second color are alternately arranged and arrangement cycles of the color-sensitivity characteristics are staggered in a column direction from each other, and
wherein in a 2n-th column and a (2n+2)th column of the light-sensitive pixel array, the light-sensitive pixels of which the color-sensitivity characteristic corresponds to the first color and the light-sensitive pixels of which the color-sensitivity characteristic corresponds to a third color are alternately arranged and arrangement cycles of the color-sensitivity characteristics are staggered in the column direction from each other.

3. An image signal processor for receiving a color-mixed image signal obtained by additively synthesizing respective lines within the predetermined range of line numbers in a column direction in the solid-state image pickup device according to claim 1 and for generating an image signal for each color component on the basis of the color-mixed image signal, the image signal processor comprising a color component calculating portion,
wherein the color component calculating portion acquires a synthesized signal value Sⱼ for each partial column Fⱼ (1≦j≦L) constituting the partial column set on the basis of the image signal obtained by the additive synthesis, and calculates Cₖ (1≦k≦L) satisfying a simultaneous linear equation expressed by the following equation as an image signal value of a k-th color at a sampling point corresponding to a position of the partial column set.
$${S}_{j} = {\sum }_{k = 1}^{L} {w}_{jk} {C}_{k} ( 1 ≦ j ≦ L )$$

4. An image signal processor for receiving a color-mixed image signal obtained by additively synthesizing respective lines within a predetermined range of odd line numbers in a column direction in the solid-state image pickup device according to claim 2 and for generating an image signal for each color component on the basis of the color-mixed image signal, the image signal processor comprising a color component calculating portion,
wherein the color component calculating portion acquires a synthesized signal S_{O1} for partial columns F_{O1} positioned within the predetermined range of lines in the (2n−1)th column (n≧1) of the light-sensitive pixel array, a synthesized signal S_{O2} for partial columns F_{O2} positioned within the predetermined range of lines in the (2n+1)th column, a synthesized signal S_{E1} for partial columns F_{E1} positioned within the predetermined range of lines in the 2n-th column, and a synthesized signal S_{E2} for the partial columns F_{E2} positioned within the predetermined range of lines in the (2n+2)th column, on the basis of the image signal obtained by the additive synthesis,
calculates C_{Ok} (k=1 or 2) satisfying a simultaneous linear equation expressed by the following equation as image signal values of the k-th color at sampling points corresponding to positions of the partial column F_{O1} and the partial column F_{O2} in the light-sensitive pixel array by setting the numbers of light-sensitive pixels corresponding to the first color included in the partial columns F_{O1} and the partial columns F_{O2} to W_{O11} and W_{O21} and by setting the numbers of light-sensitive pixels corresponding to the second color to W_{O12} and W_{O22}, respectively,
$${S}_{oj} = {\sum }_{k = 1 , 2}^{} {w}_{Ojk} {C}_{Ok} ( j = 1 , 2 )$$
and calculates C_{Ek} (k=1 or 3) satisfying a simultaneous linear equation expressed by the following equation as image signal values of the k-th color at sampling points corresponding to positions of the partial columns F_{E1} and the partial columns F_{E2} in the light-sensitive pixel array by setting the numbers of light-sensitive pixels corresponding to the first color included in the partial columns F_{E1} and the partial columns F_{E2} to W_{E11} and W_{E21} and by setting the numbers of light-sensitive pixels corresponding to the third color to W_{E13} and W_{E23}, respectively,
$${S}_{Ej} = {\sum }_{k = 1 , 3}^{} {w}_{Ejk} {C}_{Ek} ( j = 1 , 2 )$$
